(19) United States
(12) Patent Application Publication
(10) Pub. No.: US 2012/0301597 A1
(43) Pub. Date: Nov. 29, 2012

(54) SYSTEMS AND METHODS FOR PRODUCING A COMPOSITION OF FIBER

(75) Inventor: Jason Alan Bootsma, Sioux Falls, SD (US)

(73) Assignee: POET RESEARCH, INC., Sioux Falls, SD (US)

(21) Appl. No.: 13/480,131

(22) Filed: May 24, 2012

Related U.S. Application Data
(60) Provisional application No. 61/489,635, filed on May 24, 2011.

(51) Int. Cl. A23L 1/10

(52) U.S. Cl. 426/618; 426/455; 426/452

(57) ABSTRACT

Systems and methods for generating a composition of fiber and the composition of fiber from corn are provided. Raw fiber is washed with de-starched water at between about 60 and 200° F. for between approximately 5 and 20 minutes. The washed fiber is dewatered and rewashed, under similar conditions, with process water. The second wash fiber is dewatered, dried, and milled to generate processed fiber. The processed fiber may have a composition of less than about 10% moisture, at least about 85% fiber on a dry weight basis, less than about 2-4% fat on a dry weight basis, less than about 1.5% ash on a dry weight basis, less than about 9% starch on a dry weight basis, a low sulfite content, and less than about 2% starch. Additionally, the fiber may contain less than about 0.1 ppb Aflatoxin, 0.1 ppm Fumonison, 0.2 ppm Deoxynivalenol, and 75 ppb Zearalenone.

### CROSS-REFERENCE

This application claims the benefit of U.S. Provisional Application Ser. No. 61/489,635, filed May 24, 2011, and entitled “SYSTEMS AND METHODS FOR PRODUCING A COMPOSITION OF FIBER”, the entirety of which is expressly incorporated herein by reference.

### FIELD

The subject disclosure relates to systems and methods for producing a composition of fiber from corn and also relates to the composition of fiber from corn.

### BACKGROUND

Ethanol traditionally has been produced from grain-based feedstocks (e.g., corn, sorghum/milo, barley, wheat, soybeans, etc.), or from sugar (e.g., sugar cane, sugar beets, etc.).

In a conventional ethanol plant, corn, sugar cane, other grain, beets, or other plants are used as a feedstock and ethanol is produced from starch contained within the corn or other plant feedstock. In the case of a corn facility, corn kernels are cleaned and milled to prepare starch-containing material for processing. Corn kernels can also be fractionated to separate the starch-containing material (e.g., endosperm) from other matter (such as fiber and germ). Initial treatment of the feedstock varies by feedstock type. Generally, however, the starch and sugar contained in the plant material is extracted using a combination of mechanical and chemical means.

After the extraction, the fiber and germ portions of the corn kernel remain available for other purposes. Often, germ material may be added to animal feed, or sold as a valuable co-product. Similarly, the fiber from a fractionation ethanol plant may be ideally suited for processing in order to derive a food grade product.

The corn fiber may be utilized in food applications, such as, for example, breakfast cereal, cereal bars, muffins, breads, and other baked goods. Fiber utilized in these applications should have a high dietary fiber content (e.g., above about 80 percent), a low starch content, a low moisture content to retard microbial growth, and a low sulfur (e.g., sulfite and/or sulfide) content.

Conventionally, corn fiber is derived from wet mill ethanol plants. The process of wet milling the corn kernels can generate excessive sulfur content in the resulting fiber. Dry fractionation, however, does not add sulfur to the fiber and does not use long steep times that foster bacterial growth.

### SUMMARY

The disclosed aspects relate to systems and methods for generating a composition of fiber. The various aspects disclosed herein are unique due to codependence on a fractionation ethanol production facility. In particular, the raw fiber utilized in such aspects may be derived from a dry fractionation mill. The remaining components of the corn may be utilized at the ethanol production facility to generate ethanol (endosperm component) or as an animal feed co-product (germ component).

In some embodiments, the raw fiber can be washed with de-starched water to generate a first wash fiber. Wash can be at between about 60° F. and about 200° F. and may last between approximately 5 and 20 minutes with mechanical mixing. A heat exchanger may be utilized to control the wash temperature. The first wash fiber may be dewatered using a screw press or other suitable apparatus.

The dewatered fiber cake can be washed a second time using process water. The same (or substantially the same) mixing, time, and temperature ranges of the first wash can be applicable to the second wash. The process water may be potable grade water in some cases. The washed fiber can be again dewatered and dried. The dried fiber can be then milled to generate the processed fiber.

The liquid recovered from the dewatering step may be collected as starch water. The starch water may be processed by a starch concentrator to generate high solid starch water and the de-starched water (useable in the first wash as wash water). The high solids starch water can be provided to a fermentation system of the ethanol production facility for production of additional ethanol.

The final fiber product may have a composition of less than about 10% moisture, at least about 85% fiber on a dry weight basis, less than about 2-4% fat on a dry weight basis, less than about 1.5% ash on a dry weight basis, less than about 9% starch on a dry weight basis, and a low sulfite content. The fiber may also include less than about 2% starch. Additionally, the fiber may contain low mycotoxin levels, such as less than about 0.1 ppb Aflatoxin, less than about 0.1 ppm Fumonison, less than about 0.2 ppm Deoxynivalenol, and less than about 75 ppb Zearalenone.

Note that the various features described above may be practiced alone or in combination. These and other features will be described in more detail below in the detailed description and in conjunction with the following figures.

### DESCRIPTION OF THE DRAWINGS

In order that the disclosed aspects may be more clearly ascertained, some embodiments will now be described, by way of example, with reference to the accompanying drawings, in which:

FIG. 1 is a perspective view of a biorefinery comprising an ethanol production facility, in accordance with some embodiments;

FIGS. 2A and 2B are process flow diagrams illustrating examples of ethanol production processes from corn to ethanol, in accordance with some embodiments;

FIG. 3 is an example schematic block diagram illustrating a system for generating fiber, in accordance with some embodiments;

FIG. 4 is an example flow chart diagram illustrating a process for generating fiber, in accordance with some embodiments;

TABLE 1 provides example data for the composition of raw fiber on a dry weight basis, in accordance with some embodiments;

TABLE 2 provides example data for the composition of processed fiber on a dry weight basis, in accordance with some embodiments; and

TABLE 3 provides example data for mycotoxin levels before and after washing the fiber, in accordance with some embodiments.

### DESCRIPTION OF THE EMBODIMENTS

Various aspects will now be described in detail with reference to several embodiments thereof as illustrated in the accompanying drawings. In the following description, numerous specific details are set forth in order to provide a thorough understanding of embodiments of the various aspects. It will be apparent, however, to one skilled in the art, that embodiments may be practiced without some or all of these specific details. In other instances, well known process steps and/or structures have not been described in detail in order to not unnecessarily obscure the various aspects. The features and advantages of embodiments may be better understood with reference to the drawings and discussions that follow.

To provide for fiber that has low sulfur content, and to obtain benefits of generating food grade fiber from an ethanol production facility, the disclosed aspects relate to systems and methods that produce a low sulfur, food grade fiber composition from a dry fractionation corn ethanol production facility. Such systems and methods can provide a valuable co-product to existing ethanol production facilities and can provide a high quality fiber product for human consumption.

Further, the disclosed aspects relate to the composition of fiber from corn. Corn can be fractionated into a fiber component, an endosperm component, and a germ component. The fiber component can be refined to produce the composition of fiber with a high total dietary fiber (TDF) content (e.g., in a range of about 80 to 90 percent dry weight), a low starch content (e.g., in a range of around 0.5 to 5 percent dry weight), a low sulfite content (e.g., less than about 5 parts per million dry weight), and a low concentration of microbial contaminants (e.g., no more than about 1000 colony forming unit per gram). Various processes may be employed to refine corn fiber, including: a washing process and a mechanical separation process. The washing process can be configured to produce corn fiber with improved total dietary fiber concentration.

Generally, there can be significant economic benefits if the fiber production facility that generates fiber from corn is part of, or co-located with, an ethanol production facility. This is because the fiber component of the corn may be utilized to generate the fiber product, while the endosperm (starch) portion of the corn may be utilized to generate ethanol and other co-products (such as Dried Distillers Grains). Further, dry milled fiber, such as that generated at a fractionation ethanol plant can have lower microbial contamination and sulfur content than traditional fiber sources.

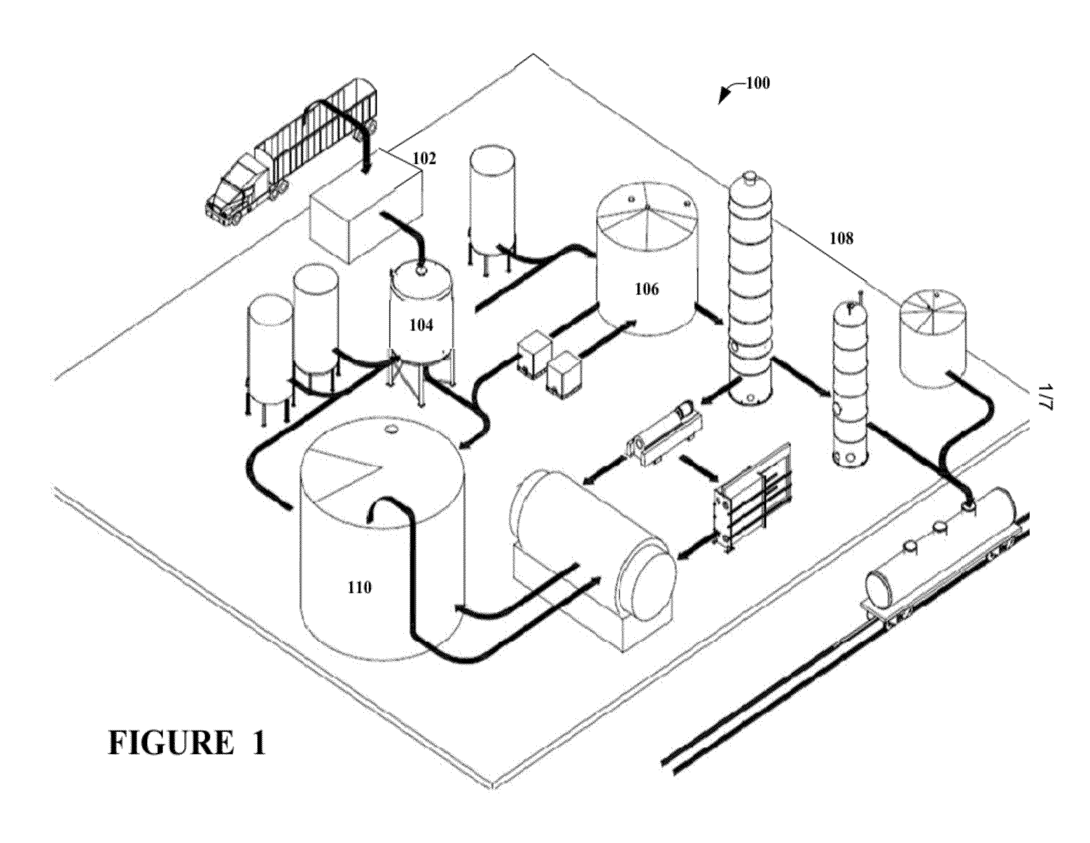

Referring to FIG. 1, an example biorefinery 100 comprising an ethanol production facility configured to produce ethanol from corn is shown. The example biorefinery 100 can comprise an area 102 where corn (or other suitable material including, but not limited to, biomass, sugars, and other starch products) is delivered and prepared to be supplied to the ethanol production facility and co-located fiber production facility. The ethanol production facility can comprise an apparatus 104 for preparation and treatment (e.g., milling) of the corn into corn flour. Part of the milling process also separates the corn into three component materials: the fiber bran, endosperm, and germ. The endosperm flour may be suitable for fermentation into fermentation product in a fermentation system 106. The ethanol production facility can also comprise a distillation system 108 in which the fermentation product is distilled and dehydrated into ethanol. The biorefinery may also comprise, in some embodiments, a by-product treatment system 110 (shown as comprising a centrifuge, a dryer, and an evaporator).

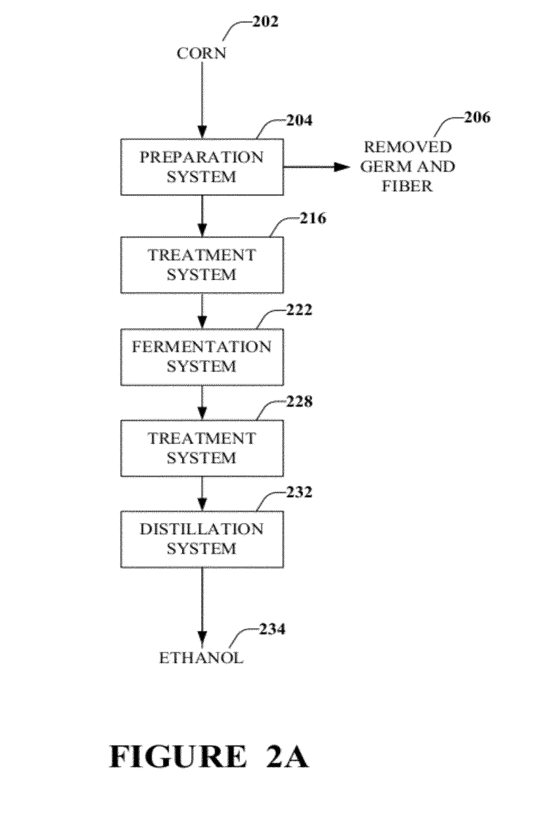

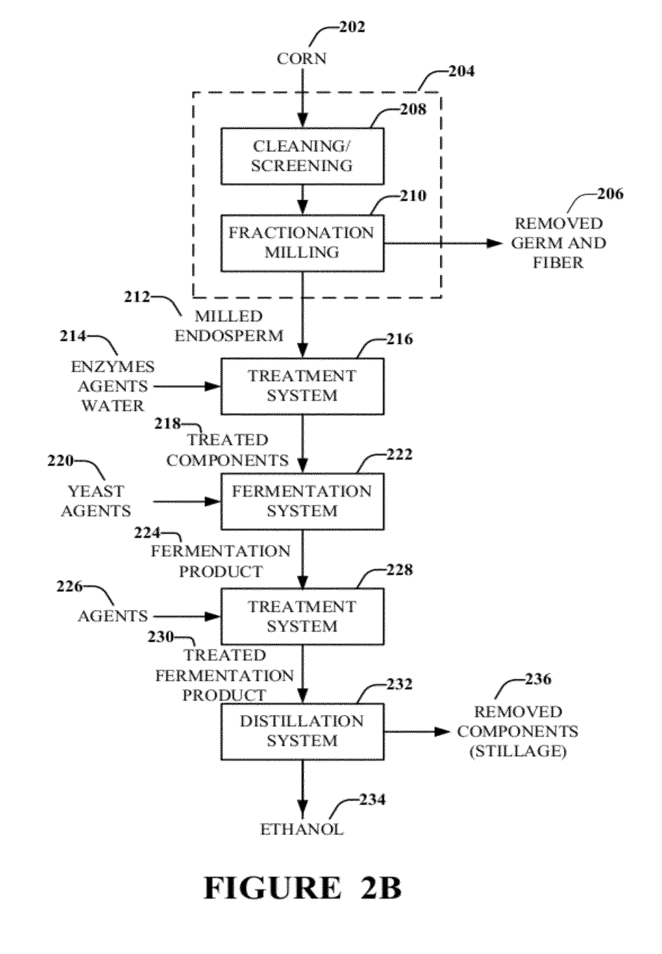

Referring to FIGS. 2A and 2B, in an ethanol production process, corn 202 (or other suitable feed material) may be prepared for further treatment in a preparation system 204 configured to remove germ and fiber 206. As shown in FIG. 2B, the preparation system 204 may comprise cleaning or screening 208 to remove foreign material, such as rocks, dirt, sand, pieces of corn cobs and stalk, and other unfermentable material (e.g., removed components). Clean corn output can be then tempered with water. After cleaning or screening 208, the tempered corn may be fractionated into component materials, and the sizing of the endosperm component may be reduced by milling 210 to facilitate further processing. The milled endosperm 212 can be slurried with water, enzymes and agents 214 to facilitate the conversion of starch into sugar (e.g. glucose), such as in a first treatment system 216. The sugar (e.g., treated component 218) can be converted into ethanol by an ethanologen (e.g. yeast or other agents 220) in a fermentation system 222. The product of fermentation (fermentation product 224) is beer, which comprises a liquid component (including ethanol and water and soluble components) and a solids component (including unfermented particulate matter (among other things)). The fermentation product may be treated with agents 226 in a second treatment system 228. The treated fermentation product 230 is sent to a distillation system 232. In the distillation system 232, the (treated) fermentation product can be distilled and dehydrated into ethanol 234. In some embodiments, the removed components 236 (e.g., whole stillage), which comprise water, soluble components, oil, and unfermented solids (e.g., the solids component of the beer with substantially all ethanol removed), may be dried into dried distillers grains (DDG) in a third treatment system (where the removed components may be treated with agents) and sold as an animal feed product. Other co-products, for example, syrup (and oil contained in the syrup), may also be recovered from the stillage.

The thin stillage, that results when solids are removed from the whole stillage, can be used as a backset during the fermentation process and can also be used to increase the nutrient content of DDGS (Distillers Dried Grains with Solubles).

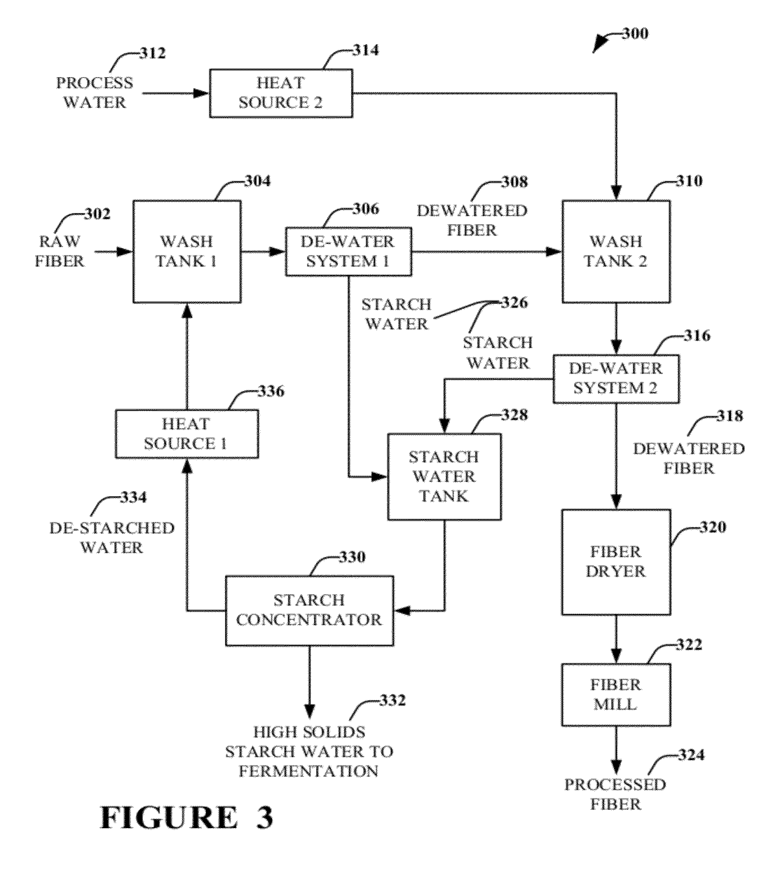

Referring now to FIG. 3, an example schematic block diagram illustrating a system 300 for generating fiber is provided, in accordance with some embodiments. In this example diagram, a two stage wash system is detailed. It should be readily understood that fiber treatment systems may include more or fewer wash stages as is appropriate for a given fiber source and product specification. For example, if the incoming fiber is from a particularly starch free and clean source, it may be desirous to have a single wash stage. On the other hand, if the incoming raw fiber is particularly dirty or impure, or if the final specifications are for an ultra pure product, three or more wash stages may be utilized.

In this example fiber processing system 300, raw fiber 302 may be received from fractionated corn of an ethanol production facility fractionation mill (e.g., fractionation milling 210). The raw fiber 302 can be dry milled raw fiber, according to an aspect. In some embodiments, the raw fiber 302 may include corn bran; however, in some embodiments, the raw fiber may be derived from some other feedstock, such as sorghum bran, rice bran, or other suitable bran source.

The raw fiber 302 may be provided to a first wash tank 304 where heated de-starched water can be provided, and, through mechanical agitation, the fiber can be washed a first time. Fiber may be slurried in the wash tank at varying concentrations, but between about 5 and 25% solids are desirable. Further, the water may be heated to between around 60 and 200 degrees Fahrenheit. The washed fiber may be provided to a first dewatering system 306 for substantial removal of the liquids. The first dewatering system 306 may include a screw press, centrifuge, or other known dewatering device. In the case of a screw press, dewatering may be performed using a 0.015 inch screen and a 10 kilogram weight on the screw press, for example.

The dewatered fiber 308 may be provided to a second wash tank 310. Additionally, heated process water 312 may be provided to the second wash tank 310. Process water 312 may be from a municipal water source, or may be from another process system from the ethanol plant (e.g., cooling tower water). Generally, the process water needs to meet some threshold for purity, as the wash water quality affects the composition of the processed fiber.

The process water 312 may be heated via a heat source 314 prior to being added to the second wash tank 310. The heat source 314 may include a water heater, heat exchanger, or other suitable heat source. Being co-located with an ethanol production facility provides an added benefit of a readily available heat source (in the form of steam and heat exchanger devices).

Once the heated process water 312 has been added to the dewatered fiber 308 in the second wash tank 310, it may be mechanically agitated in order to perform the second wash on the fiber. The fiber may then be dewatered by a second dewatering system 316. Any suitable system for dewatering, such as a screw-press or centrifuge, may be utilized.

The dewatered fiber 318 may be provided to a fiber dryer 320. Fiber may be dried to a suitable moisture content in order to prevent the growth of contaminants. In accordance with some aspects, the fiber can be dried to a moisture of less than about 10%. The fiber may be milled to a suitable consistency at a fiber mill 322 to generate processed fiber 324. Processed fiber may be sold for any number of downstream food additive purposes.

Returning to the dewatering systems 306 and 316, the starch water 326 removed from the fiber can be conveyed to a starch water tank 328 for storage. The starch water may be supplied to a starch water concentrator 330 for concentrating the starch water. This may be performed using screens and membranes, centrifuge systems, and reverse osmosis systems, for example. The concentrated high solids starch water 332 may be supplied to the ethanol plant fermentation system (e.g., fermentation system 222) for conversion of the starch to ethanol. The de-starched water 334 may be heated by a heat source 336 and supplied to the first wash tank 304 for the washing of a next batch of raw fiber 302.

In accordance with some aspects, the processed fiber can be a composition of fiber comprising: at least 85% fiber on a dry weight basis, less than about 4% fat on a dry weight basis, less than about 1.5% ash on a dry weight basis, less than about 9% protein on a dry weight basis, and less than about 40 ppm sulfite. In some aspects, the composition of fiber comprises less than about 2% starch on a dry weight basis. In another aspect, the composition of fiber comprises less than about 1.5% starch on a dry weight basis. In a further aspect, the composition of fiber comprises less than about 2% fat on a dry weight basis. According to some aspects, the composition of fiber comprises less than about 0.1 ppb Aflatoxin. In another aspect, the composition of fiber comprises less than about 1 ppm Fumonison. In a further aspect, the composition of fiber comprises less than about 0.2 ppm Deoxynivalenol (DON). In another aspect, the composition of fiber comprises less than about 75 ppb Zearalenone. In yet another aspect, the composition of fiber comprises about 15 ppm sulfite.

It is readily understood by those skilled in the art that such a system could be readily expanded, if desired, to include greater numbers of wash stages. For example, it is conceivable that a three stage wash system may be desired whereby the final stage can be washed with process water, and the used wash water may be de-starched and provided to the second stage as the wash water. The resulting twice-used wash water may again be de-starched and supplied to the first wash stage as a wash water component. In such a way, less process water can be utilized to clean (or fully clean) the fiber, thereby reducing the water demands of the fiber production process.

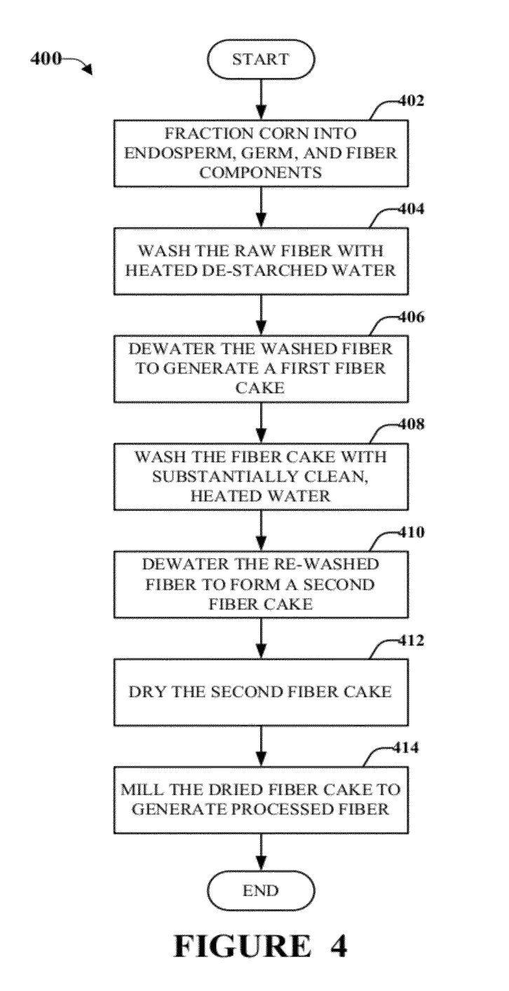

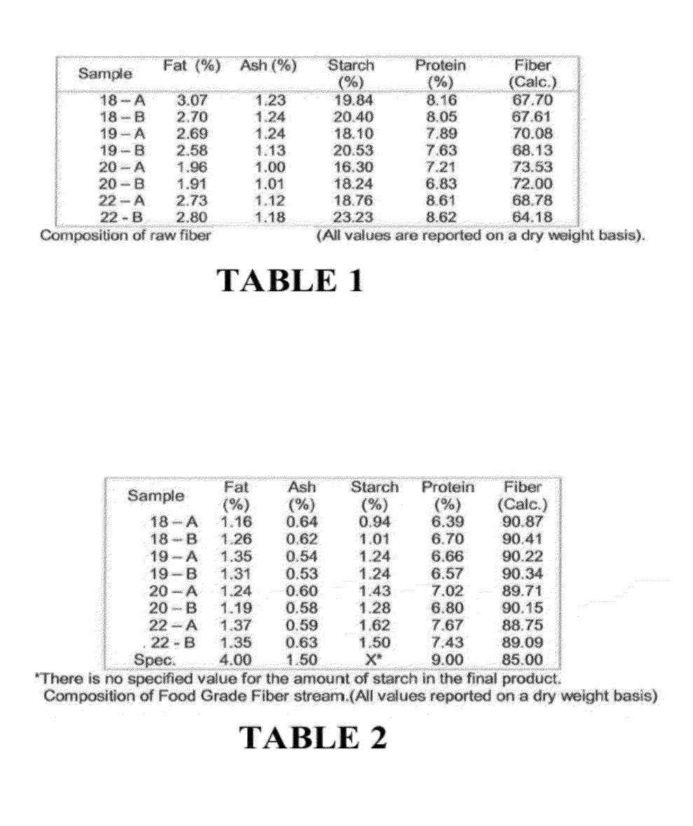

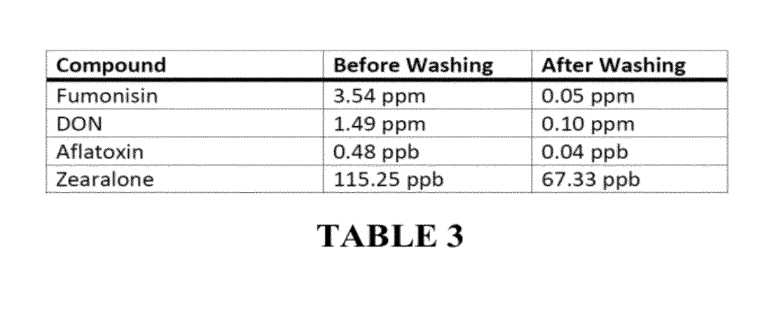

FIG. 4 is an example flow chart diagram 400 illustrating a process for generating fiber, in accordance with some embodiments. In an aspect, the fiber can be a food grade fiber. In this process, the corn (or other suitable fiber source) can be fractionated (at 402) into fiber, endosperm, and germ components. For example, the corn can be fractionated in an ethanol production facility and dry milled raw fiber can be received from the ethanol production facility.

The raw fiber can be washed with heated de-starched water (at 404). In an implementation, washing the raw fiber can be performed with the de-starched water at a temperature of about 60 to 200° F. For example, a heat exchanger can be utilized to increase the temperature of the de-starched water. The de-starched water can be recovered after a second wash, according to an aspect. In another example, washing the raw fiber can be performed with mechanical agitation for about 5 to 20 minutes. The washed fiber can be dewatered (at 406) to generate a first fiber cake. In an implementation, dewatering the washed fiber can include utilizing a screw press.

The first fiber cake can be washed (at 408) with substantially clean, heated water. In an implementation, the first fiber cake can be washed with process water. In an implementation, the process water can be at a temperature of about 60 to 200° F. For example, a heat exchanger can be utilized to increase the temperature of the process water. In another implementation, washing the dewatered first fiber cake can be performed with mechanical agitation for about 5 to 20 minutes. In an example, the process water can be potable grade water.

The fiber can be dewatered a second time (at 410) to generate a second fiber cake. In an implementation, dewatering the fiber a second time can include utilizing a screw press. The fiber cake may be dried (at 412) and milled (at 414) to generate a processed fiber product. For example, the fiber cake can be dried to a moisture of less than about 10%.

In a further implementation, the process can include recovering starch water from the fiber that is dewatered the second time and from the dewatered first fiber cake. The process can also include concentrating starch in the starch water to generate a high solid starch water and the de-starched water. Additionally, the process can include supplying the high solid starch water to a fermentation system at the fractionation ethanol production facility.

A series of limited examples were conducted according to an exemplary embodiment of a system (as shown in FIG. 3) in an effort to determine suitable apparatus and operating conditions for the production of food grade fiber from a corn ethanol fractionation plant. The following examples are intended to provide clarity to some embodiments and means of operation; given the limited nature of these examples, they are not intended to limit the scope of the disclosed aspects.

### EXAMPLE

In this example, samples for collection and analysis were produced by back calculating how much water would be needed to produce a 5% mixture of a known amount of fiber from a fractionation ethanol plant. The fiber concentration calculation took into account the moisture of the fiber. A 200 gallon tank was filled with the calculated amount of recycle water, including all solids, from the second screw press as described above with respect to FIG. 3. Additional water from the first screw press was added as needed to meet the calculated volume requirement. The recycle water was heated to approximately 160° F. by circulating through a shell-in-tube heat exchanger with process steam on the shell. The heat exchanger was bypassed and the water was recirculated back into the tank. The fiber was added to produce a 5% mixture of fiber in water. The mixture containing 5% solids was agitated using both the recirculation loop and mechanical mixing for a period of 10 minutes, The mixture was then passed through the screw press, which brought the solids content up to 43-45%. The washed fiber was collected in a 55 gallon drum and weighed. The liquid stream corning from the first screw press was collected and maintained at a temperature of 140° F. for later use. A second wash of the fiber was performed by calculating and adding the needed amount of process water to obtain a 5% solids mixture in the tank. The water was heated to 180° F by circulation through the shell-in-tube heat exchanger. The heat exchanger was bypassed and the fiber was added to the tank, The solution was mixed by recirculation and mechanical mixing for 10 minutes. The mixture was then passed through the screw press to yield fiber at 43-45% solids. The water stream from the second screw pressing was collected in a tote and maintained at a temperature of 140° F. for later use. The fiber was allowed to fall into a drum paddle dryer. The paddle dryer was adjusted so that the steam pressure in the jacket was at 45 psi. The fiber was kept in the dryer by plugging the exit until a moisture level of less than 6% was obtained. The dryer was then emptied into a tared fiber-drum, and the weight noted.

Eight samples were collected over a four-day period and compositions were analyzed pre-processing and post-processing. TABLE 1 provides example data for the composition of raw fiber on a dry weight basis. In contrast, TABLE 2 provides example data for the composition of processed fiber on a dry weight basis. The processing resulted in a dramatic reduction in starch content, reduction of fat and protein. Total fiber content is increased to around 90% after processing. In fact, as compared to specifications, all samples were shown to perform better than required.

Further, the processing of the raw fiber resulted in a reduction of mycotoxins in the product. TABLE 3 provides example data for mycotoxin levels (before and after washing) in the fiber. This reduction in toxins was unexpected because many of these toxins are not considered water soluble. A possible explanation for this reduction in toxins is the material that is being washed out has a higher amount of mycotoxin present, or these toxins are mostly on the surface of the removed starch and other components, so even though the toxins themselves are not water soluble they can be removed by washing off the components to which they are bound. This result is different from what traditionally has been experienced in washing processes with wet milled fiber. This could be due to the steeping process (used in wet milling) causing the mycotoxins to be driven into the fiber and making the rinsing less effective.

The embodiments as disclosed and described in the application (including the FIGURES and Examples) are intended to be illustrative and explanatory. Modifications and variations of the disclosed embodiments, for example, of the apparatus and processes employed (or to be employed) as well as of the compositions and treatments used (or to be used), are possible; all such modifications and variations are intended to be within the scope of the disclosed aspects.

The word “exemplary” is used to mean serving as an example, instance, or illustration. Any embodiment or design described as “exemplary” is not necessarily to be construed as preferred or advantageous over other embodiments or designs, nor is it meant to preclude equivalent exemplary structures and techniques known to those of ordinary skill in the art. Rather, use of the word exemplary is intended to present concepts in a concrete fashion, and the disclosed subject matter is not limited by such examples.

The term “or” is intended to mean an inclusive “or” rather than an exclusive “or.” To the extent that the terms “comprises,” “has,” “contains,” and other similar words are used in either the detailed description or the claims, for the avoidance of doubt, such terms are intended to be inclusive in a manner similar to the term “comprising” as an open transition word without precluding any additional or other elements.

What is claimed is:

1. A method for producing food grade fiber, comprising:
receiving dry milled raw fiber from a fractionation ethanol production facility;
washing the dry milled raw fiber with de-starched water to generate a first wash fiber, wherein the de-starched water is recovered after a second wash;
dewatering the first wash fiber;
washing the dewatered first wash fiber with process water to generate a second wash fiber;
dewatering the second wash fiber;
drying the dewatered second wash fiber; and
milling the dried second wash fiber to generate processed fiber.

2. The method of claim 1, wherein the washing the dry milled raw fiber is performed with the de-starched water at a temperature at about 60 to 200° F.

3. The method of claim 2, further comprising utilizing a heat exchanger to increase the temperature of the de-starched water.

4. The method of claim 1, wherein the washing the dry milled raw fiber is performed with mechanical agitation for about 5 to 20 minutes.

5. The method of claim 1, wherein the washing the dewatered first wash fiber is performed with the process water at a temperature at about 60 to 200° F.

6. The method of claim 5, further comprising utilizing a heat exchanger to increase the temperature of the process water.

7. The method of claim 1, wherein the washing the dewatered first wash fiber is performed with mechanical agitation for about 5 to 20 minutes.

8. The method of claim 1, wherein the process water is potable grade water.

9. The method of claim 1, further comprising:
recovering starch water from the dewatering the second wash fiber and the dewatering the first wash fiber; and
concentrating the starch in the starch water to generate a high solid starch water and the de-starched water.

10. The method of claim 9, further comprising supplying the high solid starch water to a fermentation system at the fractionation ethanol production facility.

11. The method of claim 1, wherein the dewatering the first wash fiber comprises utilizing a screw press.

12. The method of claim 1, wherein the dewatering the second wash fiber comprises utilizing a screw press.

13. The method of claim 1, wherein the drying the dewatered second wash fiber is to a moisture of less than about 10%.

14. A composition of fiber comprising:
at least about 85% fiber on a dry weight basis;
less than about 4% fat on a dry weight basis;
less than about 1.5% ash on a dry weight basis;
less than about 9% protein on a dry weight basis; and
less than about 40 ppm sulfite.

15. The composition of fiber of claim 14, further comprising less than about 2% starch on a dry weight basis.

16. The composition of fiber of claim 14, further comprising less than about 1.5% starch on a dry weight basis.

17. The composition of fiber of claim 14, further comprising less than about 2% fat on a dry weight basis.

18. The composition of fiber of claim 14, further comprising less than about 0.1 ppb Aflatoxin.

19. The composition of fiber of claim 14, further comprising less than about 0.1 ppm Fumonison.

20. The composition of fiber of claim 14, further comprising less than about 0.2 ppm Deoxynivalenol.

21. The composition of fiber of claim 14, further comprising less than about 75 ppb Zearalenone.

22. The composition of fiber of claim 14, further comprises about 15 ppm sulfite.
